(19) United States
(12) Patent Application Publication
(10) Pub. No.: US 2019/0033094 A1
(43) Pub. Date: Jan. 31, 2019

(54) NAVIGATION APPARATUS, NAVIGATION METHOD, AND NAVIGATION SYSTEM

(71) Applicant: TOYOTA JIDOSHA KABUSHIKI KAISHA, Toyota-shi (JP)

(72) Inventors: Miharu HANAI, Obu-shi (JP); Daisuke HIGASHI, Tokyo (JP)

(73) Assignee: TOYOTA JIDOSHA KABUSHIKI KAISHA, Toyota-shi (JP)

(21) Appl. No.: 16/026,927

(22) Filed: Jul. 3, 2018

(30) Foreign Application Priority Data
Jul. 28, 2017 (JP) 2017-147066

(51) Int. Cl. G01C 21/36; G06F 17/30

(52) U.S. Cl. CPC G01C 21/3682; G01C 21/3664; G06F 17/30241; G01C 21/3614; G01C 21/3667

(57) ABSTRACT

A navigation apparatus includes: a search area setting unit configured to set a search area the search area being an area surrounded by a boundary line input by a user on a map screen displayed on a display unit; a posting message acquisition unit configured to acquire a posting message relevant to a point within the search area from a social networking service; and a display controller configured to display the posting message on the map screen so as to be associated with the point relevant to the posting message within the search area.

### INCORPORATION BY REFERENCE

The disclosure of Japanese Patent Application No. 2017-147066 filed on Jul. 28, 2017 including the specification, drawings and abstract is incorporated herein by reference in its entirety.

### BACKGROUND

### 1. Technical Field

The present disclosure relates to a navigation apparatus, a navigation method, and a navigation system.

### 2. Description of Related Art

In the related art, there is known a navigation apparatus capable of searching for a facility located within a search area, which is an area designated by a user, from a data base and presenting the searched facility to the user.

For example, Japanese Unexamined Patent Application Publication No. 2004-184168 (JP 2004-184168 A) discloses a technique in which a user designates an area by touching a map with a finger through a touch panel to draw a trajectory in a loop shape and searches for a facility desired by the user within the area in a car navigation apparatus.

### SUMMARY

However, in the related art, it is possible to search for a facility in a category desired by the user within the search area, but it is difficult for the user to determine whether or not the searched facility is actually a facility relevant to the user's preference.

The disclosure provides a navigation apparatus, a navigation method, and a navigation system capable of presenting a user with a facility within an area designated by the user so that the user can easily determine whether or not the facility is relevant to the user's preference.

A first aspect of the disclosure relates to a navigation apparatus including a search area setting unit, a posting message acquisition unit, and a display controller. The search area setting unit is configured to set a search area, the search area being an area surrounded by a boundary line input by a user on a map screen displayed on a display unit. The posting message acquisition unit is configured to acquire a posting message relevant to a point within the search area from a social networking service. The display controller is configured to display the posting message on the map screen so as to be associated with the point relevant to the posting message within the search area.

As described above, on the map screen, a plurality of points where posting messages of the social networking service are present is clearly indicated by the display of the posting messages relevant to the points. Therefore, the user can easily specify a plurality of points where the posting messages of the social networking service are present, on the map screen. Then, for each of the points, the user can easily grasp detailed information (image, text, and the like) of a facility corresponding to the point from the posting message displayed so as to be associated with the point. Therefore, the user can easily determine whether or not each of a plurality of facilities corresponding to the points is a facility relevant to the user's preference.

In this specification, the “posting message” means all kinds of information posted to the social networking service, such as text, images, and voice posted to the social networking service.

In the navigation apparatus according to the first aspect of the disclosure, the display controller may be configured to display the posting message on the map screen based on preference information of the user so as to be associated with the point relevant to the posting message, the posting message being relevant to the point within the search area, the posting message including contents relevant to a preference of the user.

As described above, each of the points clearly indicated by the display of the posting messages on the map screen is a facility having a high possibility of being relevant to the user's preference. Therefore, the user can easily determine whether or not each of the facilities corresponding to the points is a facility relevant to the user's preference.

The navigation apparatus according to the first aspect of the disclosure may further include a category setting unit configured to set a category selected by the user for the search area, and the display controller may be configured to display the posting message belonging to the set category on the map screen so as to be associated with the point relevant to the posting message.

As described above, each of the points clearly indicated by the display of the posting messages on the map screen is a facility belonging to the category selected by the user. Therefore, the user can easily determine whether or not each of the facilities corresponding to the points is a facility relevant to the user's preference.

In the navigation apparatus according to the first aspect of the disclosure, the search area setting unit may be configured to set each of a plurality of the areas formed on the map screen as the search area. The posting message acquisition unit may be configured to acquire the posting message relevant to the point within the search area from the social networking service for each of a plurality of the search areas. The display controller may be configured to display the posting message on the map screen so as to be associated with the point relevant to the posting message within the search area.

As described above, on the map screen, for each area designated by the user, a plurality of points where posting messages of the social networking service are present is clearly indicated by the display of the posting messages relevant to the points. As described above, the user can finely set a search area, for which a posting message needs to be presented, on the map screen. Then, for each of a plurality of search areas set by the user, the user can easily grasp detailed information (image, text, and the like) of a facility within the search area from the posting message displayed within the search area. Therefore, the user can easily determine whether or not each of a plurality of facilities corresponding to the points is a facility relevant to the user's preference.

The navigation apparatus according to the first aspect of the disclosure may further include a guide point setting unit configured to set a point relevant to the posting message selected by the user as a transit point or a destination of a guide route, the posting message being selected among the posting messages displayed on the map screen.

As described above, the user can easily set a guide route including one or more points relevant to the user's preference.

A second aspect of the disclosure relates to a navigation method including: setting an area, which is surrounded by a boundary line input by a user on a map screen displayed on a display unit, as a search area; acquiring a posting message relevant to a point within the search area from a social networking service; and displaying the posting message on the map screen so as to be associated with the point relevant to the posting message within the search area.

In the navigation method according to the second aspect of the disclosure, the displaying of the posting message may include displaying the posting message on the map screen based on preference information of the user so as to be associated with the point relevant to the posting message, the posting message being relevant to the point within the search area, the posting message including contents relevant to a preference of the user.

The navigation method according to the second aspect of the disclosure may further include setting a category selected by the user for the search area. The displaying of the posting message may include displaying the posting message belonging to the set category on the map screen so as to be associated with the point relevant to the posting message.

In the navigation method according to the second aspect of the disclosure, the setting the area as the search area may include setting each of a plurality of the areas formed on the map screen as the search area; the acquiring posting message may include acquiring the posting message relevant to the point within the search area from the social networking service for each of a plurality of the search areas; and the displaying the posting message may include displaying the posting message on the map screen so as to be associated with the point relevant to the posting message within the search area.

The navigation method according to the second aspect of the disclosure may further include setting a point relevant to the posting message selected by the user as a transit point or a destination of a guide route, the posting message being selected among the posting messages displayed on the map screen.

A third aspect of the disclosure relates to a navigation system including a communication terminal (hereinafter, referred to as a terminal) and a center server. The terminal includes: a display configured to display a map screen; an input device configured to receive an input of a boundary line on a map screen displayed on the display; a first control device including a first computer configured to set an area on the map screen, which is surrounded by the boundary line input to the input device, as a search area; and a first communication device configured to transmit information of the search area to the center server. The center server includes: a second control device including a second computer configured to acquire a posting message relevant to a point within the search area from a social networking service; and a second communication device configured to transmit the posting message to the terminal. The first control device is configured to display the posting message on the map screen so as to be associated with the point relevant to the posting message within the search area.

It is possible to present a user with a facility within the area designated by the user so that the user can easily determine whether or not the facility is relevant to the user's preference.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing the system configuration of a navigation system according to an embodiment;

FIG. 2 is a sequence diagram showing the procedure of a first process by a smartphone and a center server according to the embodiment;

FIG. 3 is a sequence diagram showing the procedure of a second process by a smartphone and a center server according to the embodiment;

FIG. 4A is a diagram showing an example of an operation of setting a destination using the smartphone according to the embodiment;

FIG. 4B is a diagram showing an example of the operation of setting a destination using the smartphone according to the embodiment;

FIG. 4C is a diagram showing an example of the operation of setting a destination using the smartphone according to the embodiment;

FIG. 5A is a diagram showing an example of an operation of setting a plurality of search areas using the smartphone according to the embodiment;

FIG. 5B is a diagram showing an example of the operation of setting a plurality of search areas using the smartphone according to the embodiment;

FIG. 6A is a diagram showing an example of an operation of displaying a posting message on a map screen using the smartphone according to the embodiment;

FIG. 6B is a diagram showing an example of the operation of displaying a posting message on the map screen using the smartphone according to the embodiment; and

FIG. 6C is a diagram showing an example of the operation of displaying a posting message on the map screen using the smartphone according to the embodiment.

### DETAILED DESCRIPTION OF EMBODIMENTS

Hereinafter, a navigation system of an embodiment of the disclosure will be described with reference to the diagrams.

System Configuration of Navigation System 10

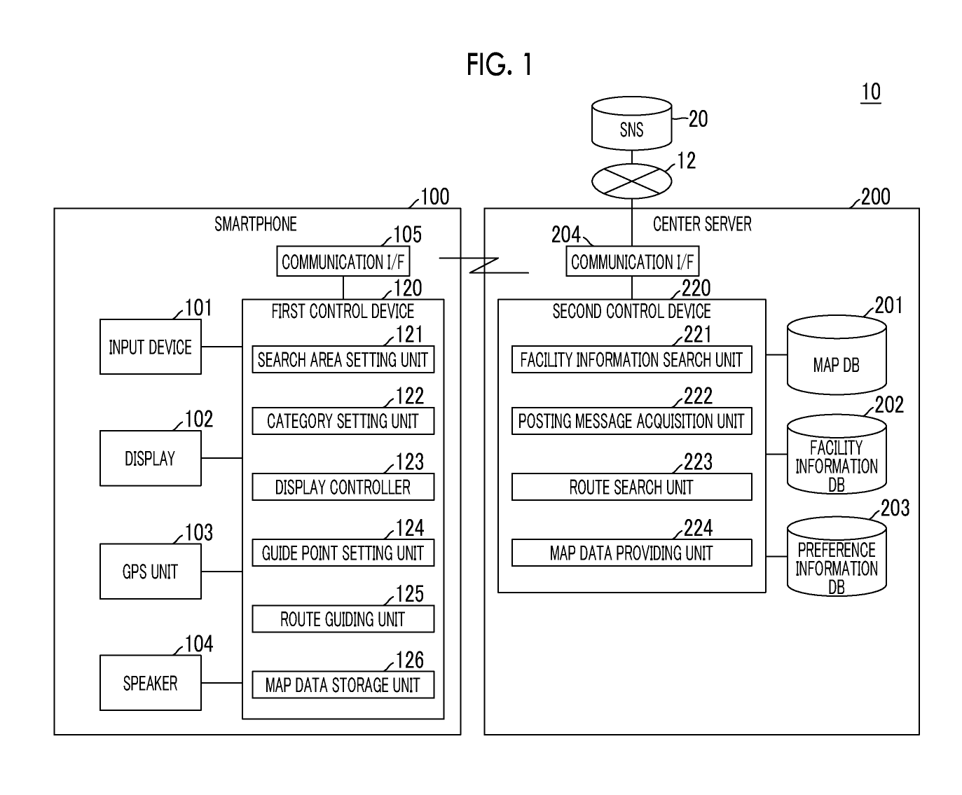

FIG. 1 is a diagram showing the system configuration of the navigation system 10 according to an embodiment. The navigation system 10 shown in FIG. 1 is configured to include a smartphone 100 and a center server 200. The navigation system 10 is a system capable of providing facility information relevant to the user's preference, information of a route to the destination, and the like from the center server 200 to the smartphone 100 by using the navigation service of the center server 200 from the navigation application of the smartphone 100. That is, the center server 200 functions as a navigation server, and the smartphone 100 functions as a navigation terminal. In the present embodiment, a function of a “navigation apparatus” described in the claims is realized by the combination of the center server 200 and the smartphone 100.

In FIG. 1, one smartphone 100 is shown. In practice, however, the navigation system 10 includes a plurality of smartphones 100 (each has the same configuration as the smartphone 100 shown in FIG. 1). That is, in the navigation system 10, navigation services of the center server 200 can be used from the smartphones 100 (a plurality of users).

Center Server 200

The center server 200 is an apparatus installed in a facility outside the vehicle (for example, a facility managed by a navigation service providing company). The center server 200 is connected to a network 12. Examples of the network 12 include the Internet and a public wireless line. The center server 200 can access a social networking service (hereinafter, referred to as an SNS) 20 through the network 12. The center server 200 can provide various kinds of information (for example, facility information, posting message, and guide route information) to the smartphone 100 through wireless communication with the smartphone 100 (for example, Wireless-Fidelity (Wi-Fi) (registered trademark)).

As shown in FIG. 1, the center server 200 includes a map data base (DB) 201, a facility information DB 202, a preference information DB 203, a communication inter-face (I/F) 204, and a second control device 220.

The map DB 201 stores map data. The map data includes a plurality of pieces of node data and a plurality of pieces of link data. The node data is data corresponding to an intersection. The link data is data corresponding to a road interval between nodes.

The facility information DB 202 stores a plurality of pieces of facility information. For example, each piece of facility information includes information of a facility name, position information (latitude and longitude), a category, an address, a zip code, a telephone number, a detailed comment, an image, or the like.

The preference information DB 203 stores a plurality of pieces of preference information for each user (specifically, for each user identifier (ID) assigned to each user). For example, each piece of preference information includes information of a category, an area, a facility, or the like that the user likes. Each piece of preference information may include information fixedly set by keyword input or the like, or may include information dynamically set from information, such as a destination search history, using a known analysis processing or the like.

The communication I/F 204 controls communication with the outside. For example, the communication I/F 204 controls communication with the SNS 20 through the network 12. For example, the communication I/F 204 controls communication with the smartphone 100 by wireless communication.

The second control device 220 is a device that controls processing on the center server 200 side in a case where the user uses the navigation service from the smartphone 100. As shown in FIG. 1, the second control device 220 includes a facility information search unit 221, a posting message acquisition unit 222, a route search unit 223, and a map data providing unit 224 as its functions.

In a case where a search area is set by the smartphone 100 (search area setting unit 121), the facility information search unit 221 searches for facility information of facilities within the search area, which is facility information relevant to the user's preference, from the facility information DB 202. The “facility information relevant to the user's preference” is facility information including a specific keyword relevant to the user's preference, for example. The facility information search unit 221 may search for all pieces of facility information matching the conditions described above, or may search for a predetermined number of pieces of facility information (for example, top three pieces of facility information in descending order of relevance to the user's preference) matching the conditions described above. The facility information search unit 221 can specify the user's preference based on the user's preference information stored in the preference information DB 203.

In a case where a search area is set by the smartphone 100 (search area setting unit 121), the posting message acquisition unit 222 acquires a posting message, which is relevant to a point within the search area and includes contents relevant to the user's preference, from the SNS 20. The “posting message relevant to a point within the search area” is a posting message associated with information (latitude and longitude, address, facility name, and the like) indicating the point within the search area, for example. The “posting message including the contents relevant to the user's preference” is a posting message including a specific keyword relevant to the user's preference, for example. The posting message acquisition unit 222 may acquire all posting messages matching the conditions described above, or may acquire a predetermined number of posting messages (for example, top three posting messages in descending order of relevance to the user's preference) matching the conditions described above.

In a case where a destination is set by the smartphone 100 (guide point setting unit 124), the route search unit 223 searches for a route from the current location of the smartphone 100 to the destination based on the map data stored in the map DB 201. In a case where a transit point is further set by the smartphone 100 (guide point setting unit 124), the route search unit 223 re-searches for a route from the current location of the smartphone 100 to the destination through the transit point based on the map data stored in the map DB 201.

Here, the route search unit 223 can search for a plurality of recommended routes. For example, the route search unit 223 can search for a plurality of recommended routes by specifying a road suitable for the vehicle type, a facility frequently used by the user, a road frequently used by the user, and the like based on the type of the vehicle used by the user, the travel history of the vehicle used by the user, and the like and variously combining the specified roads and facilities.

According to a destination, the route search unit 223 can also search for a recommended route through a facility relevant to the destination. For example, in a case where the destination is a “camp site”, a recommended route through a supermarket for purchasing food items and the like is searched for.

The recommended routes searched for by the route search unit 223 are provided to the smartphone 100 and displayed on a display 102 of the smartphone 100, thereby being presented to the user. The user can select any one desired recommended route, among the recommended routes that have been presented, as a route used for route guidance.

In a case where the smartphone 100 displays a map screen of which map data is not stored in the smartphone 100, the map data providing unit 224 provides the map data of the map screen to the smartphone 100.

The second control device 220 is configured to include hardware components, such as a central processing unit (CPU), a main storage device (for example, a read only memory (ROM) and a random access memory (RAM)), and an auxiliary storage device (for example, a hard disk drive (HDD) and a flash memory). Each function of the second control device 220 described above is realized, for example, in a case where the CPU executes a program stored in the main storage device or the auxiliary storage device in the second control device 220.

The center server 200 may be physically configured to include one information processing apparatus, or may be physically configured to include a plurality of information processing apparatuses. In the latter case, the information processing apparatuses may be connected to each other through a network.

Smartphone 100

The smartphone 100 is a mobile terminal owned by a user. The smartphone 100 can receive various kinds of information (for example, facility information, a posting message, and guide route information) from the center server 200 through a wireless communication line with the center server 200 (for example, a mobile phone network terminating at a base station or Wi-Fi).

The smartphone 100 can set a point, which is randomly selected by the user from a point relevant to the facility information provided from the center server 200 and a point relevant to the posting message provided from the center server 200, as a transit point or a destination and request the center server 200 to search for a route to the destination. Then, the smartphone 100 can perform route guidance to the destination using the route searched for by the center server 200.

As shown in FIG. 1, the smartphone 100 includes an input device 101, the display 102, a global positioning system (GPS) unit 103, a speaker 104, a communication I/F 105, and a first control device 120 as devices relevant to the use of the navigation service.

The input device 101 is a device used in a case where the user inputs various kinds of information (for example, designates a range of an area as a search area, selects a category, selects facility information, and selects a posting message). In the present embodiment, a touch panel is used as the input device 101. However, devices (for example, an operation button, a cross key, and a voice input device (microphone)) other than the touch panel may be used.

The display 102 is an example of a “display unit”, and is a device that displays various kinds of information (for example, a map screen, facility information, a route search result, and a guide screen at the time of route guidance). Examples of the display 102 include a liquid crystal display and an organic electro luminescence (EL) display. The GPS unit 103 detects the current location (longitude and latitude) of the smartphone 100 based on the GPS signal received from the GPS satellite. The speaker 104 is a device that outputs various voices (for example, a guide voice at the time of route guidance). The communication I/F 105 controls communication with the outside. For example, the communication I/F 105 controls communication with the center server 200 by wireless communication.

The first control device 120 is a device that controls processing on the smartphone 100 side in a case where the user uses the navigation service from the smartphone 100. As shown in FIG. 1, the first control device 120 includes the search area setting unit 121, a category setting unit 122, a display controller 123, the guide point setting unit 124, a route guiding unit 125, and a map data storage unit 126.

The search area setting unit 121 sets an area surrounded by the boundary line, which is formed on the map screen based on the user input, as a search area. For example, the user performs an operation of tracing the surface of the input device 101 (touch panel) with a finger on the map screen displayed on the display 102, so that a rough area that the user thinks “I want to go to this place” is surrounded by a boundary line written by the operation. In response to this, the search area setting unit 121 sets the area surrounded by the boundary line as a search area. In a case where the search area is set by the search area setting unit 121, information indicating the search area (information indicating the range of latitude and longitude) is transmitted to the center server 200 by the communication I/F 105. The search area setting unit 121 can set a plurality of search areas on the map screen.

The category setting unit 122 sets a category selected by the user for the search area set by the search area setting unit 121. Examples of the category include landscape, meal, and event, but are not limited thereto. Here, in a case where the search areas are set by the search area setting unit 121, the category setting unit 122 can set a category selected by the user for each of the search areas.

The display controller 123 controls display of various kinds of information by the display 102.

For example, for a map screen displayed for the first time, the display controller 123 displays the map screen on the display 102 based on map data provided from the center server 200 (map data providing unit 224).

For example, for a map screen displayed for the second time and subsequent times, the display controller 123 displays the map screen on the display 102 based on map data stored in the map data storage unit 126.

For example, the display controller 123 displays a route to the destination searched for by the center server 200 (route search unit 223) on the display 102 so as to be superimposed on the map screen.

For example, the display controller 123 displays facility information searched for by the center server 200 (facility information search unit 221) on the map screen displayed on the display 102 so as to be associated with a point (point within the search area) relevant to the facility information.

For example, the display controller 123 displays a posting message acquired by the center server 200 (posting message acquisition unit 222) on the map screen displayed on the display 102 so as to be associated with a point (point within the search area) relevant to the posting message.

In a case where a specific category is set by the category setting unit 122 for the search area set on the map screen, the display controller 123 can display solely the posting message of the specific category within the search area.

The guide point setting unit 124 sets a transit point and a destination of the guide route. For example, the guide point setting unit 124 can set a point corresponding to facility information selected by the user, among a plurality of pieces of facility information (facility information of facilities within the search area) presented to the user, as a destination of the guide route. For example, the guide point setting unit 124 can set a point corresponding to a posting message selected by the user, among a plurality of posting messages (posting messages relevant to points within the search area) presented to the user, as a transit point of the guide route.

The route guiding unit 125 performs route guidance from the current location of the smartphone 100 to the destination set by the guide point setting unit 124 based on the route searched for by the center server 200 (route search unit 223). The route guidance by the route guiding unit 125 involves display of a guide screen on the display 102 and output of a guide voice by the speaker 104. The center server 200 (route search unit 223) can perform a route search with a point other than the current location of the smartphone 100 (for example, a point randomly designated by the user) as a departure point. In response to this, the route guiding unit 125 can perform route guidance from a point other than the current location of the smartphone 100 to the destination set by the guide point setting unit 124.

The map data storage unit 126 stores map data provided from the center server 200 (map data providing unit 224). As described above, for the map screen once displayed, the display controller 123 can redisplay the map screen based on the map data stored in the map data storage unit 126. Therefore, since it is possible to suppress the frequency of communication with the center server 200, it is possible to obtain effects, such as improvement in the display speed of the map screen.

The first control device 120 is configured to include hardware components, such as a CPU, a main storage device (for example, a ROM and a RAM), and an auxiliary storage device (for example, a HDD and a flash memory). Each function of the first control device 120 shown in FIG. 1 is realized, for example, in a case where the CPU executes a program stored in the main storage device or the auxiliary storage device in the first control device 120.

The program executed by the CPU may be provided in advance in a state in which the program is introduced into the smartphone 100, or may be provided from the outside and introduced into the smartphone 100. In the latter case, the program may be provided by an external storage medium (for example, a universal serial bus (USB) memory, a memory card, and a CD-ROM), or may be provided by downloading from a server on a network (for example, the Internet).

Procedure of First Process by Smartphone 100 and Center Server 200

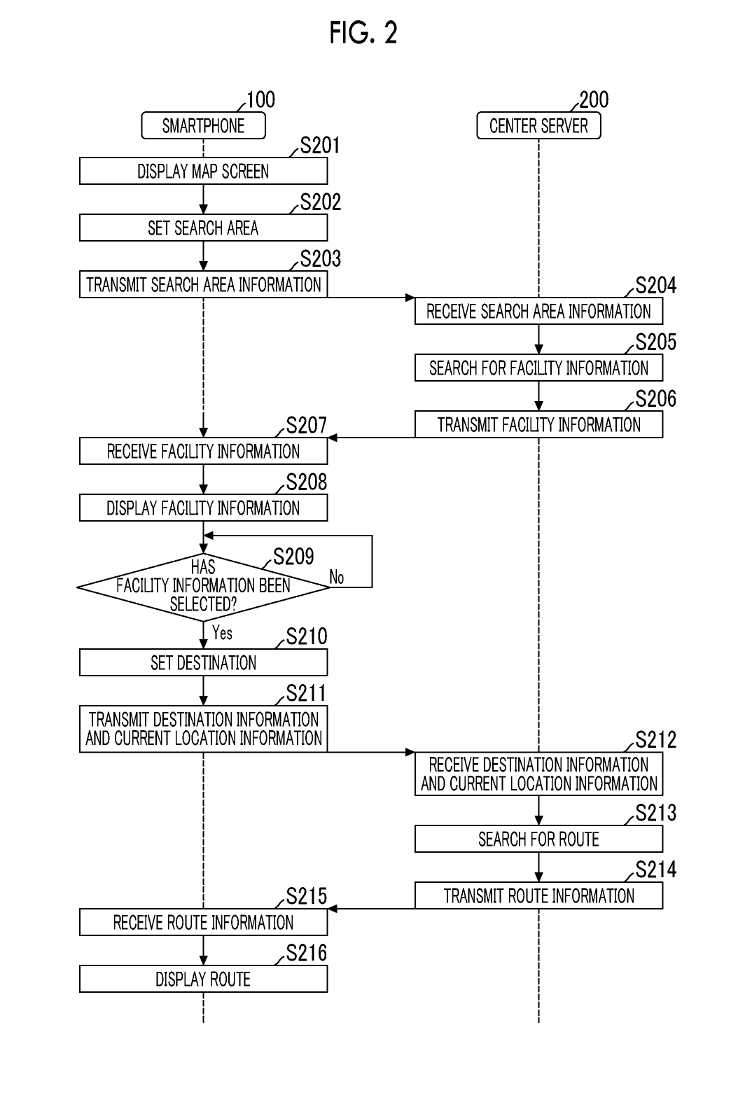

FIG. 2 is a sequence diagram showing the procedure of a first process by the smartphone 100 and the center server 200 according to an embodiment. The process shown in FIG. 2 is a process until the user sets a search area and a destination from the smartphone 100 and the smartphone 100 displays a plurality of recommended routes to the destination. The process shown in FIG. 2 is started, for example, in a case where a predetermined user operation (for example, an operation of pressing a destination search button) for performing a destination search is performed in the smartphone 100.

First, in the smartphone 100, the display controller 123 displays a map screen on the display 102 (step S201). For example, first, the display controller 123 displays a map of the vicinity of the current location of the smartphone 100 on the display 102 with a predetermined scale. By operating the input device 101, the user can scroll the map displayed on the display 102 and change the scale of the map displayed on the display 102.

The search area setting unit 121 sets an area surrounded by the boundary line, which is formed on the map screen based on the user input, as a search area (step S202). Then, the communication I/F 105 transmits search area information indicating the range of the search area set in step S202 (information indicating the range of latitude and longitude) to the center server 200 (step S203).

In the center server 200, in a case where the communication I/F 204 receives the search area information transmitted from the smartphone 100 (step S204), the facility information search unit 221 searches for facility information of facilities within the search area specified according to the search area information, which is facility information relevant to the user's preference, from the facility information DB 202 (step S205). Then, the communication I/F 204 transmits the facility information searched for in step S205 to the smartphone 100 (step S206).

In the smartphone 100, in a case where the communication I/F 105 receives the facility information transmitted from the center server 200 (step S207), the display controller 123 displays the facility information on the map screen displayed on the display 102 so as to be associated with the point relevant to the facility information (step S208).

Thereafter, in a case where the guide point setting unit 124 detects that any facility information has been selected from the facility information displayed in step S208 (step S209), the guide point setting unit 124 sets a point (for example, the location of the facility) corresponding to the selected facility information as a destination (step S210). Then, the communication I/F 105 transmits destination information indicating the destination set in step S210 and current location information indicating the current location of the smartphone 100 detected by the GPS unit 103 to the center server 200 (step S211).

In the center server 200, in a case where the communication I/F 204 receives the destination information and the current location information transmitted from the smartphone 100 (step S212), the route search unit 223 searches for the recommended routes from the current location of the smartphone 100 specified according to the current location information to the destination specified according to the destination information, based on the map data stored in the map DB 201 (step S213). Then, the communication I/F 204 transmits route information indicating the recommended routes searched for in step S213 to the smartphone 100 (step S214).

In the smartphone 100, in a case where the communication I/F 105 receives the route information transmitted from the center server 200 (step S215), the display controller 123 displays all of the recommended routes to the destination specified according to the route information on the map screen displayed on the display 102 (step S216). Then, the series of processes shown in FIG. 2 are ended.

Procedure of Second Process by Smartphone 100 and Center Server 200

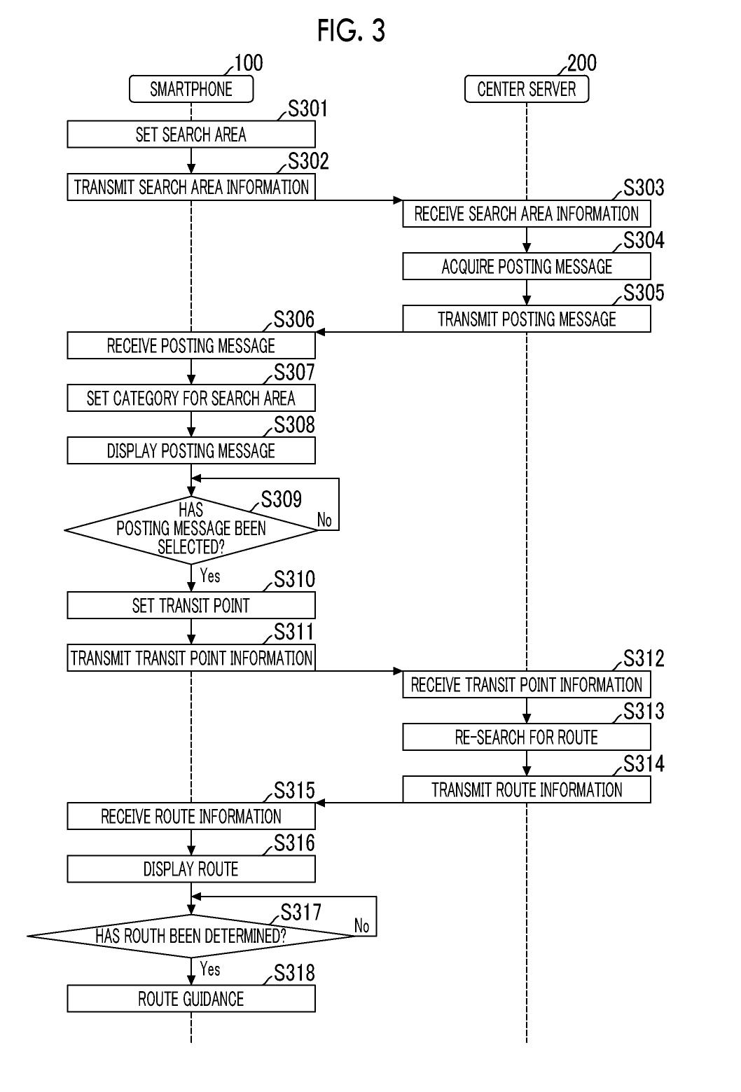

FIG. 3 is a sequence diagram showing the procedure of a second process by the smartphone 100 and the center server 200 according to an embodiment. The process shown in FIG. 3 is a process until the user sets a transit point from the smartphone 100 and the smartphone 100 displays a route through the transit point. The process shown in FIG. 3 is started subsequent to the process shown in FIG. 2, for example, in a case where all of the recommended routes to the destination are displayed on the map screen by the process shown in FIG. 2.

First, in the smartphone 100, the search area setting unit 121 sets an area surrounded by the boundary line, which is formed on the map screen (on the map screen on which all of the recommended routes are displayed) based on the user input, as a search area (step S301). Here, one or more search areas can be set on the map screen. Then, the communication I/F 105 transmits search area information indicating the range of the search area set in step S302 (information indicating the range of latitude and longitude) to the center server 200 (step S302).

In the center server 200, in a case where the communication I/F 204 receives the search area information transmitted from the smartphone 100 (step S303), the posting message acquisition unit 222 acquires a posting message, which is relevant to the point within the search area specified according to the search area information and includes contents relevant to the user's preference, from the SNS 20 (step S304). Then, the communication I/F 204 transmits the posting message searched for in step S304 to the smartphone 100 (step S305).

In the smartphone 100, in a case where the communication I/F 105 receives the posting message transmitted from the center server 200 (step S306), the category setting unit 122 sets a category selected by the user for the search area set in step S301 (step S307). Then, the display controller 123 displays a posting message including the contents relevant to the category set in step S307, among the posting messages received in step S306, on the map screen displayed on the display 102 so as to be associated with the point relevant to the posting message (step S308).

Thereafter, in a case where the guide point setting unit 124 detects that one posting message has been selected from the posting messages displayed in step S308 (step S309), the guide point setting unit 124 sets a point corresponding to the selected posting message as a transit point (step S310). In this example, the point corresponding to the selected posting message is set as a transit point. However, the point corresponding to the selected posting message can also be set as a new destination. Then, the communication I/F 105 transmits transit point information indicating the transit point set in step S310 to the center server 200 (step S311).

In the center server 200, in a case where the communication I/F 204 receives the transit point information transmitted from the smartphone 100 (step S312), the route search unit 223 sets the point specified according to the transit point information as a transit point based on the map data stored in the map DB 201, and re-searches for a route to the destination (step S313). Then, the communication I/F 204 transmits route information indicating the route re-searched for in step S313 to the smartphone 100 (step S314).

In the smartphone 100, in a case where the communication I/F 105 receives the route information transmitted from the center server 200 (step S315), the display controller 123 displays all of the routes to the destination specified according to the route information on the display 102 (step S316).

Thereafter, in a case where the route guiding unit 125 detects that the route displayed in step S316 has been determined as a route to be used for route guidance (step S317), the route guiding unit 125 performs route guidance from the current location of the smartphone 100 to the destination based on the route determined as a route used for route guidance (step S318). Then, the series of processes shown in FIG. 3 are ended.

Example of Operation of Setting Destination

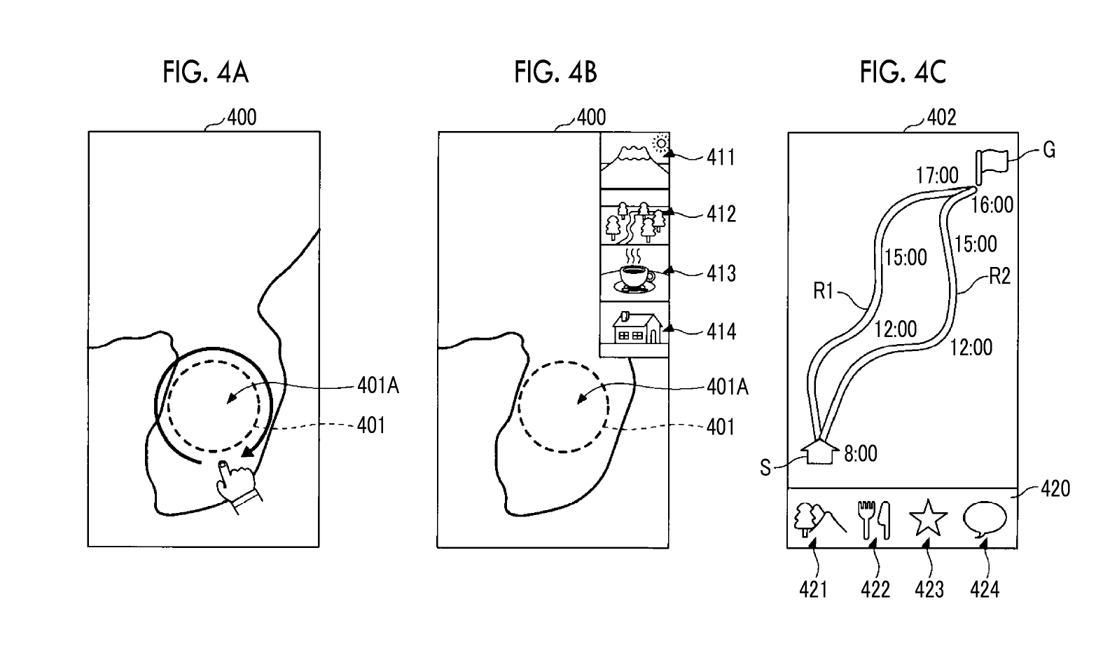

FIGS. 4A to 4C are diagrams showing an example of an operation of setting a destination using the smartphone 100 according to the embodiment.

A map screen 400 shown in FIG. 4A is an example of a map screen displayed on the display 102 of the smartphone 100. As shown in FIG. 4A, the user performs an operation of tracing the surface of the input device 101 (touch panel) with a finger on the map screen 400, so that a rough area that the user thinks that “I want to go to this place” is surrounded by a boundary line 401 written by the operation. As a result, the area surrounded by the boundary line 401 can be set as a search area 401A. In the example shown in FIG. 4A, a circular search area is set on the map screen. However, the search area is not limited thereto, and a search area having a shape (for example, an elliptical shape or a rectangular shape) other than the circular shape may be set on the map screen. In the example shown in FIG. 4A, solely one search area is set on the map screen. However, the number of search areas is not limited thereto, and a plurality of search areas may be set on the map screen.

Then, in a case where the search area 401A is set in the smartphone 100, the center server 200 (facility information search unit 221) searches for a plurality of pieces of facility information, which is facility information of facilities within the search area 401A and is relevant to the user's preference, from the facility information DB 202. Then, in the smartphone 100, the pieces of facility information searched for by the center server 200 is displayed on the map screen 400 as shown in FIG. 4B. In the example shown in FIG. 4B, four pieces of facility information 411 to 414 (representative images) are displayed on the map screen 400. All of the four pieces of facility information 411 to 414 are facility information of facilities within the search area 401A, which is facility information relevant to the user's preference (four pieces of highest facility information in descending order of relevance to the user's preference).

The facility information searched for from the facility information DB 202 differs depending on the scale of the map screen 400 in a case where the search area 401A is set. For example, in a case where the scale of the map screen 400 is relatively large (for example, 1/2500), facility information associated with the scale in advance is searched for as facility information to be displayed on the relatively wide map screen, such as “Mount OO” and “OO circuit”. On the other hand, in a case where the scale of the map screen 400 is relatively small (for example, 1/25000), facility information associated with the scale in advance is searched for as facility information to be displayed on the relatively narrow map screen, such as “Mount OO kids' country” and “OO farm”.

The user can check the detailed information (for example, facility name, address, telephone number, and detailed comment) of the facility information by selecting one of the pieces of facility information 411 to 414 by operating the input device 101 (touch panel) on the map screen 400 shown in FIG. 4B. The user can set a point relevant to the facility information (latitude and longitude set in the facility information) as a destination by selecting one of the pieces of facility information 411 to 414 by operating the input device 101 (touch panel) on the map screen 400 shown in FIG. 4B.

In a case where the destination is set in the smartphone 100, the center server 200 (route search unit 223) searches for a plurality of recommended routes from the current location of the smartphone 100 to the destination. Then, in the smartphone 100, all of the recommended routes searched for by the center server 200 are displayed on a map screen 402 including the routes as shown in FIG. 4C. In the example shown in FIG. 4C, two recommended routes R1, R2 are displayed on the map screen 402. Both the two recommended routes R1, R2 are routes from the current location S of the smartphone 100 to a destination G set by the user, which have been searched for by the center server 200. However, the recommended route R1 and the recommended route R2 have different routes to go through.

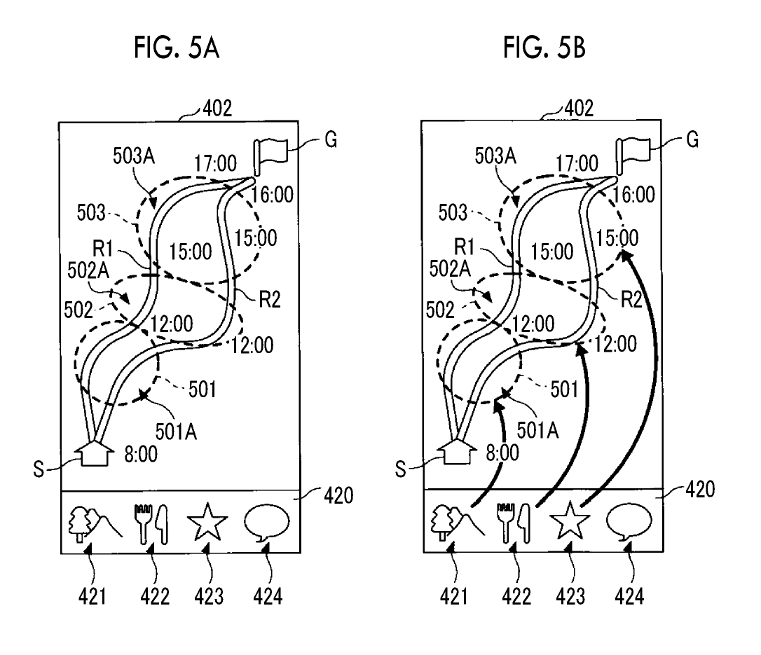

The user can set a route to be used for route guidance by selecting one of the recommended routes R1, R2 by operating the input device 101 (touch panel) on the map screen 402 shown in FIG. 4C. In FIG. 4C, an icon display area 420 is displayed on the lower side of the map screen 402. The icon display area 420 will be described later with reference to FIGS. 5A and 5B.

Example of Operation of Setting Plurality of Search Areas

FIGS. 5A and 5B are diagrams showing an example of an operation of setting a plurality of search areas using the smartphone 100 according to the embodiment.

The map screen 402 shown in FIG. 5A is the same as the map screen 402 shown in FIG. 4C, and the two recommended routes R1, R2 are displayed. As shown in FIG. 5A, the user performs an operation of tracing the surface of the input device 101 (touch panel) with a finger on the map screen 402, so that predetermined one or more areas for which information is desired are surrounded by boundary lines written by the operation. As a result, the one or more areas surrounded by the boundary lines can be set as a search area.

For example, in the example shown in FIG. 5A, an area surrounded by a boundary line 501 by the user operation is set as a search area 501A. An area surrounded by a boundary line 502 by the user operation is set as a search area 502A. An area surrounded by a boundary line 503 by the user operation is set as a search area 503A.

The user can set the category of a posting message to be displayed for each of the search areas set on the map screen 402.

For example, in the example shown in FIG. 5B, a drag-and-drop operation is performed from an icon 421 to the search area 501A by the input device 101 (touch panel). The icon 421 is an icon corresponding to the category “landscape”. By the drag-and-drop operation, “landscape” is set as the category of a posting message to be displayed for the search area 501A.

In the example shown in FIG. 5B, a drag-and-drop operation is performed from an icon 422 to the search area 502A by the input device 101 (touch panel). The icon 422 is an icon corresponding to the category “eating and drinking”. By the drag-and-drop operation, “eating and drinking” is set as the category of a posting message to be displayed for the search area 502A.

In the example shown in FIG. 5B, a drag-and-drop operation is performed from an icon 423 to the search area 503A by the input device 101 (touch panel). The icon 423 is an icon corresponding to the category “event”. By the drag-and-drop operation, “event” is set as the category of a posting message to be displayed for the search area 503A.

Example of Operation for Displaying Posting Message on Map Screen

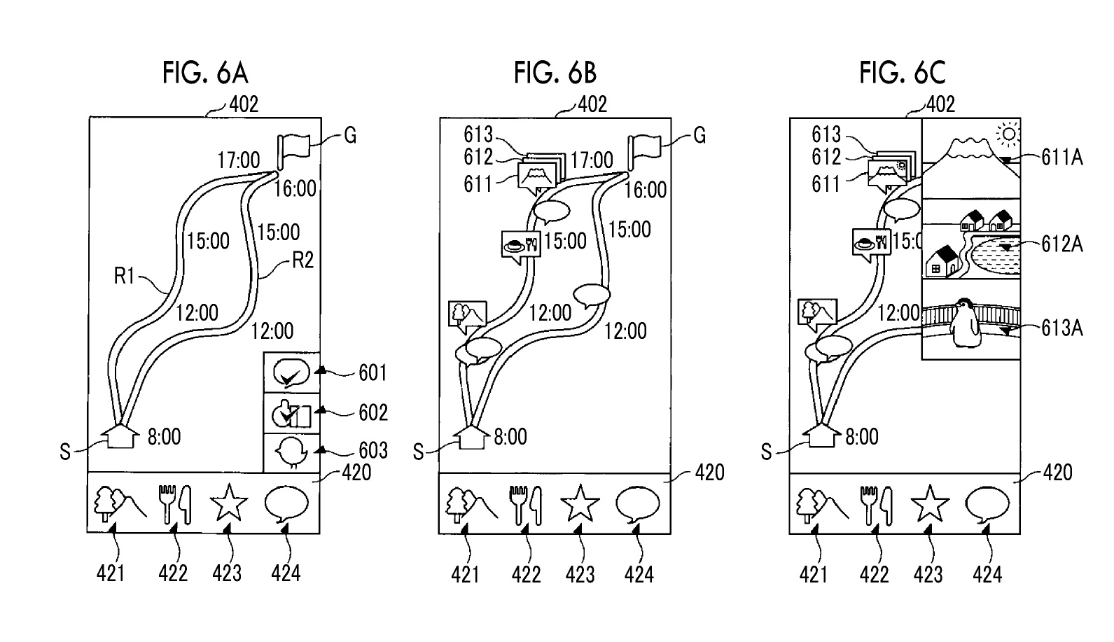

FIGS. 6A to 6C are diagrams showing an example of an operation for displaying a posting message on the map screen using the smartphone 100 according to the embodiment.

The map screen 402 shown in FIG. 6A is the same as the map screen 402 shown in FIG. 4C, and the two recommended routes R1, R2 are displayed. However, as described with reference to FIGS. 5A and 5B, on the map screen 402 shown in FIG. 6A, the three search areas 501A to 503A are set, and the category of the posting message to be displayed is set for each of the three search areas 501A to 503A.

In FIG. 6A, in a case where the icon 424 is selected by the operation of the input device 101 (touch panel), three icons 601 to 603 for each type of SNS are displayed on the map screen 402. The user can select an icon corresponding to the SNS of which a posting message is to be displayed, among the three icons 601 to 603, by operating the input device 101 (touch panel).

For example, in the example shown in FIG. 6A, the icon 601 corresponding to the first SNS and the icon 602 corresponding to the second SNS are selected. As described above, as shown in FIG. 6B, a posting message (circular balloon in the diagram) acquired from the first SNS and a posting message (square balloon in the diagram) acquired from the second SNS are displayed on the map screen 402.

In particular, as shown in FIG. 5B, in the search area 501A, solely the posting message of the category “landscape” is displayed by making a category setting for each of the search areas 501A to 503A. In the search area 502A, solely the posting message of the category “eating and drinking” is displayed. In the search area 503A, solely the posting message of the category “event” is displayed.

The user can check the detailed information (detailed image, detail text, and the like) of the posting message, facility information of the facility corresponding to the posting message (for example, facility name, address, telephone number, and detailed comment), and the like by selecting one of the posting messages displayed on the map screen 402 by operating the input device 101 (touch panel) on the map screen 402 shown in FIG. 6B. Then, the user can set a point corresponding to the posting message, which is randomly selected on the map screen 402, as a transit point of the guide route or a new destination by operating the input device 101 (touch panel).

For example, in the example shown in FIG. 6C, since a set of three posting messages 611 to 613 acquired from the second SNS is selected on the map screen 402, detailed images 611A to 613A of the three posting messages 611 to 613 are displayed on the map screen 402. The user can further select one of the detailed images 611A to 613A by operating the input device 101 (touch panel). Then, the user can set a point corresponding to the selected detailed image as a transit point of the guide route or a new destination by operating the input device 101 (touch panel).

As described above, according to the navigation system 10 of the present embodiment, an area surrounded by the boundary line, which is formed on the map screen based on the user input, can be set as a search area, and the posting message of the SNS 20 relevant to a point within the search area can be displayed on the map screen so as to be associated with a point relevant to the posting message. As described above, for each of the points presented within the search area, the user can easily grasp detailed information (image, text, and the like) of a facility corresponding to the point from the posting message displayed so as to be associated with the point. Therefore, the user can easily determine whether or not each of a plurality of facilities corresponding to the points is a facility relevant to the user's preference.

According to the navigation system 10 of the present embodiment, a posting message that includes contents relevant to the user's preference and belongs to the category selected by the user can be displayed on the map screen so as to be associated with a point relevant to the posting message. As described above, a plurality of points more suitable for the user (points that are more likely to be actually relevant to the user's preference) can be presented to the user.

According to the navigation system 10 of the present embodiment, the user can set a plurality of search areas on the map screen. Therefore, for each of the search areas, a posting message of the SNS 20 relevant to the point within the search area can be displayed on the map screen so as to be associated with a point relevant to the posting message. As described above, since the user can finely set the search area on the map screen, a posting message relevant to the user's preference can be presented to the user for each search area.

According to the navigation system 10 of the present embodiment, a point relevant to the posting message selected by the user among the posting messages displayed on the map screen can be set as a transit point or a destination of the guide route. As described above, the user can easily set a guide route including one or more points relevant to the user's preference.

While the preferred embodiments of the disclosure have been described in detail above, the disclosure is not limited to these embodiments, and various modifications or changes can be made within the scope of the disclosure described in the claims.

In the embodiment, the smartphone 100 may be made to have some (for example, a route search function) of the functions of the center server 200.

In the embodiment, the center server 200 may be made to have some of the functions of the smartphone 100.

In the embodiment, the smartphone 100 is used as an example of the navigation terminal. However, the function of the navigation terminal may be realized by an information processing apparatus (for example, a tablet terminal and an in-vehicle car navigation apparatus) other than the smartphone 100.

In the embodiment, the center server 200 is used as an example of the navigation server. However, the function of the navigation server may be realized by an information processing apparatus (for example, an in-vehicle car navigation apparatus) other than the center server 200.

In the embodiment, in the case of setting a destination, a plurality of pieces of facility information within the search area is presented to the user (refer to FIGS. 4A to 4C). However, for example, a plurality of posting messages within the search area may be presented to the user in the same manner as in the case of setting a transit point (refer to FIGS. 6A to 6C). For example, as shown in FIG. 4A, in a case where the search area 401A is set on the map screen 400, posting messages relevant to points within the search area 401A may be displayed on the map screen 400. Then, the user may select any one of the posting messages displayed on the map screen 400 to set a point corresponding to the posting message (point where the posting message is displayed) as a destination.

In the embodiment, in the case of setting a transit point, a plurality of posting messages within the search area is presented to the user (refer to FIGS. 6A to 6C). However, for example, a plurality of pieces of facility information within the search area may be presented to the user in the same manner as in the case of setting a destination (refer to FIGS. 4A to 4C).

What is claimed is:

1. A navigation apparatus comprising:
a search area setting unit configured to set a search area, the search area being an area surrounded by a boundary line input by a user on a map screen displayed on a display unit;
a posting message acquisition unit configured to acquire a posting message relevant to a point within the search area from a social networking service; and
a display controller configured to display the posting message on the map screen so as to be associated with the point relevant to the posting message within the search area.

2. The navigation apparatus according to claim 1, wherein the display controller is configured to display the posting message on the map screen based on preference information of the user so as to be associated with the point relevant to the posting message, the posting message being relevant to the point within the search area, the posting message including contents relevant to a preference of the user.

3. The navigation apparatus according to claim 1, further comprising a category setting unit configured to set a category selected by the user for the search area, wherein the display controller is configured to display the posting message belonging to the set category on the map screen so as to be associated with the point relevant to the posting message.

4. The navigation apparatus according to claim 1, wherein:
the search area setting unit is configured to set each of a plurality of the areas formed on the map screen as the search area;
the posting message acquisition unit is configured to acquire the posting message relevant to the point within the search area from the social networking service for each of a plurality of the search areas; and
the display controller is configured to display the posting message on the map screen so as to be associated with the point relevant to the posting message within the search area.

5. The navigation apparatus according to claim 1, further comprising a guide point setting unit configured to set a point relevant to the posting message selected by the user as a transit point or a destination of a guide route, the posting message being selected among the posting messages displayed on the map screen.

6. A navigation method comprising:
setting an area, which is surrounded by a boundary line input by a user on a map screen displayed on a display unit, as a search area;
acquiring a posting message relevant to a point within the search area from a social networking service; and
displaying the posting message on the map screen so as to be associated with the point relevant to the posting message within the search area.

7. The navigation method according to claim 6, wherein the displaying the posting message includes displaying the posting message on the map screen based on preference information of the user so as to be associated with the point relevant to the posting message, the posting message being relevant to the point within the search area, the posting message including contents relevant to a preference of the user.

8. The navigation method according to claim 6, further comprising setting a category selected by the user for the search area,
wherein the displaying the posting message includes displaying the posting message belonging to the set category on the map screen so as to be associated with the point relevant to the posting message.

9. The navigation method according to claim 6, wherein:
the setting the area as the search area includes setting each of a plurality of the areas formed on the map screen as the search area;
the acquiring posting message includes acquiring the posting message relevant to the point within the search area from the social networking service for each of a plurality of the search areas; and
the displaying the posting message includes displaying the posting message on the map screen so as to be associated with the point relevant to the posting message within the search area.

10. The navigation method according to claim 6, further comprising setting a point relevant to the posting message selected by the user as a transit point or a destination of a guide route, the posting message being selected among the posting messages displayed on the map screen.

11. A navigation system comprising:
a terminal; and
a center server, wherein:
the terminal includes
a display configured to display a map screen,
an input device configured to receive an input of a boundary line on a map screen displayed on the display,
a first control device including a first computer configured to set an area on the map screen, which is surrounded by the boundary line input to the input device, as a search area, and
a first communication device configured to transmit information of the search area to the center server;
the center server includes
a second control device including a second computer configured to acquire a posting message relevant to a point within the search area from a social networking service, and
a second communication device configured to transmit the posting message to the terminal; and
the first control device is configured to display the posting message on the map screen so as to be associated with the point relevant to the posting message within the search area.
